(19) United States
(12) Patent Application Publication
(10) Pub. No.: US 2009/0131519 A1
(43) Pub. Date: May 21, 2009

(54) Use of Growth Regulators for Reducing or Preventing the Contamination of Plants and Vegetable Products by Trichothecene-Producing Mould Toxins

(75) Inventors: Wilhelm Rademacher, Limburgerhof (DE); Veronica Companys, Sant Cugat Del Valles (ES); John-Bryan Speakman, Bobenheim (DE); Helmut Merrmann, Rottenburg (DE); Dieter Strobel, Herxheim am Berg (DE); Martin Semar, Gleiszellen-Gleishorbach (DE)

Correspondence Address: BIRCH STEWART KOLASCH & BIRCH, PO BOX 747, FALLS CHURCH, VA, 22040-0747, US

(73) Assignee: BASF AKTIENGESELLSCHAFT, Ludwigshafen (DE)

(21) Appl. No.: 11/988,474

(22) PCT Filed: Jul. 18, 2006
(86) PCT No.: PCT/EP2006/064367

§ 371 Date: Jan. 8, 2008

(30) Foreign Application Priority Data
Jul. 19, 2005 (DE) 10 2005 033 686.8

(51) Int. Cl. A01N 37/16; A01N 37/08; A01P 3/00

(52) U.S. Cl. 514/529; 514/557

(57) ABSTRACT

The present invention relates to the use of growth regulators selected from acylcyclohexanedione derivatives and quaternary ammonium compounds for reducing or preventing the contamination of plants and plant products with mycotoxins formed by trichothecene-producing fungi.

The present invention relates to the use of growth regulators selected from acylcyclohexanedione derivatives and quaternary ammonium compounds for reducing or preventing the contamination of plants and plant products with mycotoxins formed by trichothecene-producing fungi.

The harvested material of all cereal species, such as wheat, barley, rye, triticale, oats, rice and corn, and also that of many other plant species, such as potato, sugar beet, tomato, pea, leek, asparagus, fodder grasses and fodder clover, can be contaminated with trichothecene toxins and other mycotoxins which originate from trichothecene-producing mold fungi. Most highly affected are triticale, oats, common wheat and in particular durum wheat. The source of these toxins are certain fungi, for example those of the genera Trichoderma, Stachybotrys and in particular Fusarium, infecting these plants. All over the world, such fusarioses are the most important cereal disease which, in addition to the classic wheat-growing regions in the USA and Canada, also affect Australia and Europe. The Fusarium fungus is mainly soil-dwelling, degrading, together with other microorganisms, plant material. It can exist on living and dead material alike. A more frequent occurrence as cereal disease is promoted by a number of factors:
Fusarium-infected organic matter on/in the soil (as inoculum), the contamination being promoted in particular by corn stubbles and residual corn straw (see, for example, A. Meier, B. Birzele, E. Oerke, U. Steiner, J. Krämer and H. Dehne, “Significance of different inoculum source for the Fusarium infection of wheat ears.”, Mycotoxin Research 1, 2001, 71-75)
sufficient moist-warm weather in spring and early summer, allowing the fungus to form sporangia
alternating periods of precipitation and sunshine for spreading the spores
flowering of the plant (especially cereal) during the period when the spores are airborne (see, for example, A. Obst, V. H. Paul, “Krankheiten and Schädlinge des Getreides” [cereal diseases and cereal pests], Verlag Th. Mann, Gelsenkirchen-Buer, 1993).

The infection of cereal with Fusarium fungi results in a characteristic ear infection where individual ears are bleached and in some cases a reddish spore coating can be observed. In most cases, the ears dry out above the infected site, and only a shriveled grain is formed there. It may well be possible that normally sized grains mature below the infected site; however, these are generally contaminated by fungus toxins. Accordingly, Fusarium fungi may not only reduce the yields, but, in particular, they also contaminate the harvested cereal with mycotoxins. Contamination of the cereal grains may take place both in the ear and during storage of the harvested material.

Following ingestion of contaminated plants and parts of plants, for example of cereal or products prepared therefrom, even minute doses of the mycotoxins contained therein may cause serious acute or chronic diseases in humans and animals. Acute adverse effects of trichothecene toxins and other mycotoxins originating from trichothecene-producing fungi on health can manifest themselves in a large number of symptoms, for example in a compromised immune system, an IgA nephropathy (Berger's Disease), nausea, kidney damage, feed refusal and vomiting in domestic animals and reduced laying performance in poultry breeding. Moreover, in man and animal these mycotoxins have estrogenic and/or mutagenic activity. In the case of bolus wheat, there is suspected to be a connection between the contamination with such toxins and the frothing over of the beer (P. Gjersten, “Gushing in Beer: Its nature, cause and prevention”, Brewers Digest 42, 1967, 80-84).

To avoid an adverse effect on health by ingestion of the abovementioned mycotoxins, national and supranational authorities have laid down which maximum amounts of mycotoxins are tolerable. Thus, the Committee on Food of the EU recommends 0.001 mg of DON (deoxynivalenol; a trichothecene toxin) per kilogram of body weight as TDI (Tolerable Daily Intake) for adults. According to the German regulation on maximum amounts of mycotoxins, cereal grains for direct consumption and in processed cereal products may contain at most 0.5 mg of DON per kilogram of cereal used. In bakers' ware and pastry, the DON contents must not exceed 0.35 mg/kg, whereas the upper limit in food for babies and infants is 0.1 mg/kg

To reduce the content of the abovementioned mycotoxins in plants and plant parts and the food products and animal feed obtained therefrom, the measures currently employed are essentially the following:
cultivation of cultivars with low susceptibility to Fusarium infection;
suitable crop rotation; in particular avoidance of corn as previous crop;
use of fungicides, such as metconazole and tebuconazole;
storage conditions which prevent the development of Fusarium fungi.

However, these measures are not yet satisfactory. In particular, the purely preventive measures (cultivation of resistant cultivars, suitable crop rotation and storage conditions) are not reliably effective, in particular when the prevailing weather conditions favor infection by mold fungi. The use of fungicides, too, is not always sufficient, in particular when there is a high infection pressure.

In general, growth regulators do not have any fungicidal action. However, certain compounds having a N-containing heterocycle and having a certain fungicidal activity, i.e. growth regulators of the triazole type (for example paclobutrazole and uniconazole), of the pyrimidine type (for example ancymidole and flurprimidole) and of the 4-pyridine type (for example inabenfide) are an exception (W. Rademacher, “Growth retardants: Effects on gibberellin biosynthesis and other metabolic pathways”, Annual Review of Plant Physiology and Plant Molecular Biology 51, 2000, 501-531).

In “Interference of selected fungicides, plant growth retardants as well as piperonyl butoxide and 1-aminobenzotriazole in trichothecene production of Fusarium graminearum (strain 4528) in vitro”, Zeitschrift für Pflanzenkrankheiten und Pflanzenschutz (Journal of Plant Diseases & Protection) 106(2), 1999, 198-212, A. Matthies, F. Walker and H. Buchenauer describe that growth regulators (ancymidole, flurprimidole and BAS 111) inhibit the formation of 3-acetyldeoxynivalenol (3-ADON; a trichothecene toxin) and also the mycelium growth in in vitro cultures of Fusarium graminearum only weakly.

In general, the effect of such compounds on the toxin content of cereal grains has hitherto been thought to be neutral to rather negative. Thus, E. Oldenburg describes in “Crop cultivation measures to reduce mycotoxin contamination in cereals”, Journal of Applied Botany and Food Quality 78, 174-177 (2004), that the combined use of growth regulators and foliar fungicides results in certain cases in an increase of the DON content in wheat, and accordingly, the author recommends a cautious use of growth regulators. A similar assessment is also reached by M. T. Fauzi and T. C. Paulit in “The effect of plant growth regulators and nitrogen on Fusarium head blight of the spring wheat cultivar Max”, Plant Disease 78, 1994, 289-292: in this work, it is reported that chlormequat chloride has no direct effect on the susceptibility of wheat ears to infection with Fusarium graminearum. However, by shortening the plant, it is easier for an infection to occur, since the ear is closer to the inoculum (plant residues in the soil). However, the trichothecene contents in the grains were not determined.

Furthermore, it is known that the acylcyclohexanedione compounds prohexadione-Ca and trinexapac-ethyl may induce resistance against attack by pathogens in certain plant species. Thus, U.S. Pat. No. 6,022,831 describes the use of acylcyclohexanediones against infection with fire blight (Erwinia amylovora) in pome fruit. WO 00/78144 describes the use of acylcyclohexanediones for increasing the resistance of crop plants against infection with certain phytopathogenic fungi. In terms of effect, only the action against scab (Venturia inaequalis) in apple and against Botrytis cinerea in grape vines is documented. However, such effects may not be triggered in all plant species and not against all pathogens. Infection of wheat with mildew, for example, cannot be reduced by pre-treatment with prohexadione-Ca. More details are given in H. Halbwirth, T. C. Fischer, S. Roemmelt, F. Spinelli, K. Schlangen, S. Peterek, E. Sabatini, C. Messina, J. B. Speakman, C. Andreotti, W. Rademacher, C. Bazzi, G. Costa, D. Treutter, G. Forkmann and K. Stich in “Induction of antimicrobial 3-deoxyflavonoids in pome fruit trees controls fire blight”, Zeitschrift für Naturforschung 58 c, 2004, 765-770.

There is a need for the more effective reduction or prevention of contamination of plants and plant products, in particular those intended for human and animal consumption, with trichothecene toxins and other toxins originating from trichothecene-forming fungi. In particular, the reduction or prevention of the contamination should be possible even in cases where, owing to high infection pressure, a sufficient control of the infection by fungicides is not possible.

Accordingly, it is an object of the present invention to provide compounds reducing or preventing the contamination of plants and plant products with toxins formed by trichothecene-producing fungi.

Surprisingly, it has been found that certain growth regulators reduce or prevent the contamination of plants or plant products with such toxins.

Accordingly, the object was achieved by using compounds selected from the group consisting of

(a) acylcyclohexanediones of the formula (I)

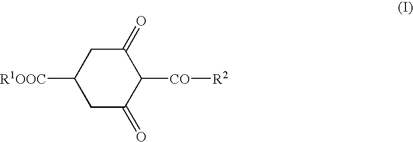

in which
R¹ is H or C₁-C₁₀-alkyl and
R² is C₁-C₁₀-alkyl or C₃-C₁₀-cycloalkyl
or salts thereof; and

(b) quaternary ammonium compounds of the formula (II)

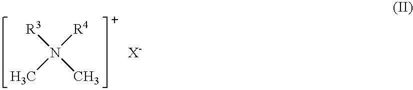

in which
R³ and R⁴ independently of one another are C₁-C₁₀-alkyl which is optionally substituted by at least one halogen atom, or are C₃-C₁₀-cycloalkyl; or
R³ and R⁴ together form a bridging unit —(CH₂)ₙ—, —(CH₂)₂—O—(CH₂)₂— or —(CH₂)—CH═CH—(CH₂)—NH—,
in which n is 4 or 5, and
X⁻ is a counteranion selected from the group consisting of halide ions, sulfate ions, C₁-C₁₀-alkylsulfonate ions, borate ions, carbonate ions and mixtures thereof,
   for reducing or preventing the contamination of plants or plant products with toxins formed by trichothecene-producing fungi.

It is assumed that the growth regulators mentioned inhibit the biosynthesis of these toxins. However, it is also possible that, additionally or alternatively, they induce or increase the resistance of the plants against attack by pathogens.

The statements below with respect to suitable and preferred embodiments of the compounds I and II and their use apply both on their own and in combination with one another.

In the context of the present invention C₁-C₁₀-alkyl is a straight-chain or branched alkyl radical, such as methyl, ethyl, propyl, isopropyl, n-butyl, sec-butyl, isobutyl, tert-butyl, pentyl, neopentyl, hexyl, heptyl, octyl, 2-ethylhexyl, nonyl or decyl. C₁-C₄-alkyl is, for example, methyl, ethyl, propyl, isopropyl, n-butyl, sec-butyl, isobutyl or tert-butyl. The alkyl radical is preferably straight-chain.

C₃-C₁₀-cycloalkyl is, for example, cyclopropyl, cyclopentyl, cyclohexyl, cycloheptyl, cyclooctyl, cyclodecyl or decalin. C₃-C₆-cycloalkyl is, for example, cyclopropyl, cyclopentyl or cyclohexyl.

Halogen is preferably fluorine, chlorine or bromine and particularly preferably chlorine. Accordingly, halide ions are preferably fluoride, chloride or bromide and particularly preferably chloride.

Sulfate ions are both the bare sulfate anion SO₄²⁻ and C₁-C₁₀-alkyl sulfate ions RO—S(O)₂—O—, in which R is C₁-C₁₀-alkyl, for example methyl sulfate, ethyl sulfate and the like. Preferred is the bare sulfate anion SO₄²⁻.

C₁-C₁₀-Alkyl sulfonate ions are anions of the formula R—S(O)₂—O—, in which R is C₁-C₁₀-alkyl, for example methylsulfonate, ethylsulfonate and the like.

Borate anions are preferably those of the formula III

1/m·[MₓB_{y}O_{z}(A)ᵥ]^{m-}·w(H₂O) (III)

in which
M is a cation of an agriculturally acceptable metal, a proton or ammonium;
A is a chelate- or complex-forming group associated with at least one boron atom or a cation M;
x is a number from 0 to 10;
y is a number from 1 to 48;
z is a number from 0 to 48;
v is a number from 0 to 24;
m is a number from 1 to 6;
w is a number from 0 to 24.

M is preferably a cation of a metal selected from the group consisting of sodium, potassium, magnesium, calcium, zinc, manganese and copper, is a proton or is ammonium.

A is preferably selected from the group consisting of hydroxycarboxylic acids, carboxylic acids, alcohols, glycols, aminoalcohols, sugars and the like.

Suitable hydroxycarboxylic acids are, for example, glycolic acid, lactic acid, mandelic acid, malic acid, tartaric acid, citric acid, other fruit acids and also hydroxyfatty acids, such as ricinoleic acid.

Suitable carboxylic acids are monocarboxylic acids, such as formic acid, acetic acid, propionic acid, valeric acid, isovaleric acid, caproic acid, enanthic acid, caprylic acid and other fatty acids, and dicarboxylic acids, such as oxalic acid, malonic acid; succinic acid, adipic acid and the like.

Suitable alcohols are, for example, C₁-C₈-alcohols, such as methanol, ethanol, propanol, isopropanol, n-butanol, sec-butanol, isobutanol, tert-butanol, pentyl alcohols, such as pentanol and amyl alcohol, hexyl alcohols, such as hexanol, heptyl alcohols, such as heptanol, and octyl alcohols, such as octanol and 2-ethylhexanol.

Suitable glycols are, for example, C₂-C₁₀-diols, such as glycol, diethylene glycol, triethylene glycol and the like.

Suitable aminoalcohols are, for example, ethanolamine, diethanolamine, triethanolamine and the like.

Suitable sugars are, for example, pentoses and hexoses, such as fructose, glucose, mannose and the like, and also disugars, such as sucrose.

x is preferably 0, in particular if M does not have one of the preferred meanings mentioned above.

y is preferably a number from 2 to 20, particularly preferably from 2 to 10, more preferably from 3 to 10, even more preferably from 3 to 7 and in particular from 3 to 5. y is especially 5.

z is preferably a number from 6 to 10, particularly preferably from 6 to 8 and in particular 8.

v is preferably 0.

w is preferably a number from 2 to 10, particularly preferably from 2 to 8 and in particular 2 or 3.

m is preferably 1 or 2 and in particular 1.

Preference is given to borates of the formula (III), in which x is zero; or M is a cation of a metal selected from the group consisting of sodium, potassium, magnesium, calcium, zinc, manganese and copper, is a proton or is ammonium; and/or y corresponds to a number from 2 to 20, preferably from 2 to 10, particularly preferably from 3 to 10, more preferably from 3 to 7, in particular from 3 to 5; and/or z corresponds to a number from 6 to 10, in particular from 6 to 8; and/or v is zero; and/or m is 1 or 2; and/or w corresponds to a number from 0 to 24.

Particular preference is given to borates of the formula (III) in which y corresponds to a number from 3 to 7, in particular from 3 to 5; z corresponds to a number from 6 to 10, in particular from 6 to 8; v is zero; and w corresponds to a number from 2 to 10, in particular from 2 to 8.

Very particular preference is given to borates of the formula (III) in which y=5; z=8; v=0; m=1; w=2 to 3 (pentaborates).

In the borates, if required, the charge is compensated via the cation M.

The borates may comprise water, for example as water of crystallization in free or coordinated form or as bound water in the form of hydroxyl groups attached to boron.

Suitable and preferred borates and processes for their preparation are known per se and described, for example, in WO 02/083732 and in the literature cited therein, the entire content of which is incorporated herein by way of reference. Further suitable borates are described, for example, in WO 99/09832, the entire content of which is incorporated herein by way of reference.

The toxins formed by trichothecene-producing fungi are both trichothecenes and toxins different therefrom originating from the same mold fungi.

The trichothecene-producing fungi are preferably those of the genera Trichoderma, Stachybotrys and, in particular, Fusarium.

Of importance in connection with the mycotoxin production in the case of the genus fusarium are, for example: F. culmorum and F. graminearum as most important species (Mauler-Machnik A. & Suty A, 2000: Aktueller Stand der internationalen Forschung zur Bekämpfung von Ährenfusariosen in Weizen [Current state of International Research on the control of ear fusarioses in wheat]. 22nd Mycotoxin Workshop, Bonn, Jun. 5-7, 2000), and furthermore also F. acuminatum, F avenaceum, F. crockwellense, F. equiseti, F. moniliforme, F. oxysporum, F. poae, F. proliferans, F. scirpi, F. sporotrichioides, F. subglutinans and F. tricinctum.

In the case of the genus Trichoderma, it is in particular the representative Trichoderma viride which is of importance in this context. The mold fungi of the genus Stachybotrys are in particular Stachybotrys chartarum.

The mycotoxins are in particular trichothecenes or zearalenone.

Zearalenone is a mycotoxin with estrogen action which is formed by various species of the genus Fusarium. Preferred substrates of the zearalenone-forming fungi are corn and oats. However, other cereal species may also be heavily infected. Since zearalenone is formed in a very late development phase of the fungus, it is found especially in highly infected cereal. Zearalenone has no acute toxicity; however, it is presumed to have carcinogenic action. In grazing animals, it causes fertility disorders, premature births and stillbirths.

The name trichothecene refers to a group of about 100 mycotoxins formed in particular by fusaria, but also by other mold fungi on plants and plant products, in particular on cereal and cereal products. Trichothecenes have a broad spectrum of biological actions. In general, trichothecenes inhibit the protein biosynthesis in mammalian cells, sometimes even at concentrations as low as 1 ng. Trichothecene poisoning causes vomiting, diarrhea, food refusal, inflammations of the gastrointestinal tract, damage to nerve cells, heart muscle, lymph system, testes, thymus and development of tissue necroses. Poisonings of animals and humans are known, for example, under the term “moldy corn toxicosis” (USA), “bean hull toxicosis” (Japan) or “alimentary toxic aleukia” (CIS). According to their chemical structure, the trichothecenes are divided into groups A to D.

Of importance are in particular the following trichothecene toxins: T-2 toxin, HT-2 toxin, neosolaniol, monoacetoxyscirpenol, diacetoxyscirpenol (DAS), 15-acetoxyscirpendiol, deoxynivalenol (DON=vomitoxin), nivalenol, 3-acetoxynivalenol, 15-acetoxynivalenol, fusarenone, T-2 tetraol and verrucarol.

Plants in which the formation of the mycotoxins mentioned is to be reduced or prevented are preferably selected from the group consisting of cereal, potato, sugar beet, tomato, pea, leek, asparagus, fodder grasses and fodder clover. Cereal is, for example, wheat, rice, corm, barley, oats, triticale and rye.

The plant products are in particular the harvested products of these plants, for example cereal grains and, in the case of corn, also the corncob, potatoes, sugar beets, tomatoes, peas, leek, asparagus and cut fodder grasses and fodder clover, for example hay.

With particular preference, the plants are selected from the group consisting of wheat, such as durum wheat or common wheat, barley, rye, triticale, oats, rice and corn.

The plant products are particularly preferably the harvested products of these plants, such as cereal grains.

The growth regulators (I) and/or (II) are used especially for reducing or preventing the contamination of wheat with the mycotoxins mentioned above.

In a preferred embodiment, the compounds (I) and/or (II) are used for reducing or preventing the contamination of plants and plant products with toxins selected from the group consisting of deoxynivalenol (DON), nivalenol (NIV) and zearalenone (ZEA).

The compounds of the formulae (I) and (II) are known and are generally used as growth regulators (growth retardants) in agriculture (see, for example, EP-A-123001, EP-A-126713, W. Rademacher, “Growth Retardants: Effects on Gibberellin Biosynthesis and Other Metabolic Pathways”, Annu. Rev. Plant. Mol. Biol. 2000, 51, 501-531).

The compounds of the formula (I) can be present either in the trione form (triketo form) I.a or in the tautomeric keto-enol forms I.b or I.c:

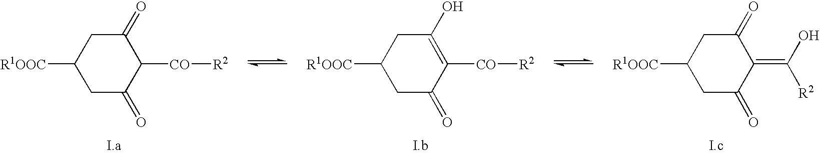

In the compounds of the formula I, R¹ is preferably H or C₁-C₄-alkyl.

R² is preferably C₁-C₄-alkyl or C₃-C₆-cycloalkyl and especially ethyl or cyclopropyl.

The salts of the acylcyclohexanedione compounds I where R¹≠H are the salts of monoanions, whereas in the case of R¹═H they may be the salts both of the mono- and the dianions of these compounds. The monoanions can be present either as carboxylate anions I.d or as enolate anions I.e or I.f:

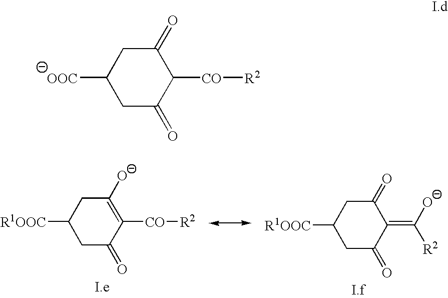

Correspondingly, in the dianion, both the carboxylate and the enolate groups are present.

Preferred cations in the salts of the compounds of the formula I are the ions of the alkali metals, preferably of lithium, sodium and potassium, of the alkaline earth metals, preferably of calcium and magnesium, and of the transition metals, preferably of manganese, copper, zinc and iron, furthermore ammonium (NH₄⁺) and substituted ammonium, where one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethyl-ammonium, diisopropylammonium, trimethylammonium, tetramethylammonium, tetraethylammonium, tetrabutylammonium, 2-hydroxyethylammonium, 2-(2-hydroxyeth-1-oxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium, such as trimethylsulfonium and sulfoxonium ions, preferably tri(C₁-C₄-alkyl)sulfoxonium. Preferred cations are furthermore chlormequat [(2-chloro-ethyl)trimethylammonium], mepiquat (N,N-dimethylpiperidinium) and N,N-dimethyl-morpholinium. Particularly preferred cations are the alkali metal cations, the alkali earth metal cations and the ammonium cation (NH₄⁺). It is in particular the calcium salt.

In the context of the present invention, the term “compounds of the formula I”, “acylcyclohexanedione of the formula I” or “growth regulators of the formula I” refers both to the neutral compounds I and to their salts.

Compounds I which are particularly preferably used according to the invention are prohexadione (R¹═H, R²=ethyl), prohexadione-calcium (calcium salt of prohexadione), trinexapac (R¹═H, R²=cyclopropyl) and trinexapac-ethyl (R¹=ethyl, R²=cyclopropyl).

In compounds of the formula (II), one of the radicals R³ or R⁴ is preferably C₁-C₁₀-alkyl and the other radical is preferably C₁-C₁₀-alkyl substituted by a halogen atom, preferably by a chlorine atom. With particular preference, R³ is methyl and R⁴ is 2-chloroethyl.

In an alternative preferred embodiment, R³ and R⁴ together form a bridging unit —(CH₂)₅—.

In a preferred embodiment of the invention, the anions X⁻ in the compounds II are selected from the group consisting of halide ions, sulfate ions and carbonate ions.

In an alternative preferred embodiment of the invention, the anions X⁻ in the compounds II are selected from the group consisting of halide ions, especially chloride, borates, especially pentaborate, and mixtures thereof.

X⁻ is particularly preferably a halide anion and in particular chloride.

The quaternary ammonium compounds of the formula (II) are especially the salt of chlormequat (salt of 2-chloroethyltrimethylammonium), in particular chlormequat chloride (2-chloroethyltrimethylammonium chloride) or the salt of mepiquat (salt of 1,1-dimethylpiperidinium), in particular mepiquat chloride (1,1-dimethylpiperidinium chloride).

It is furthermore also possible to use mixtures of the growth regulators (I) and (II) described.

In a preferred embodiment, to reduce or prevent contamination with the mycotoxins mentioned, acylcyclohexanediones (I) are used. Among these, particular preference is given to prohexadione, prohexadione-calcium, trinexapac and trinexapac-ethyl. Especially, use is made of prohexadione-calcium.

The use of compounds of the formulae (I) and/or (II) for reducing or preventing the contamination with the mycotoxins mentioned above is generally carried out by treating the plants or plant parts thereof or the plant products with these compounds. The treatment of the plants or the plant products is preferably carried out by bringing the plant or the plant parts thereof or the plant product into contact with at least one compound selected from compounds of the formulae (I) and (II). For this purpose, at least one of the compounds (I) and/or (II) is applied to the plant or plant parts thereof or to the plant product. If a plurality of compounds of the formulae (I) and/or (II) are employed, they can be applied in a mixture or separately. In the case of separate application, the individual active substances can be employed simultaneously or—as part of a treatment sequence—staggered in succession, where in the case of successive application the application is preferably within an interval of a few hours to several weeks.

The treatment of the plants or plant parts or of the plant products can be both prophylactically and therapeutically, i.e. after an infection with harmful fungi. However, it is preferably prophylactically, i.e. before the infection by the corresponding species of harmful fungi.

The timing of the application, the number of applications and the application rates specifically employed in each case have to be adapted to the prevailing conditions and have to be determined for each individual case by a person skilled in the art. In addition to the active compounds used in each case, a distinction has to be made in particular about whether intact plants are to be treated under field conditions or whether stored harvested material is to be protected against contamination by toxins.

The active compounds can be applied as such or in the form of their formulations or in the form of the use forms prepared therefrom, by spraying, atomizing, dusting, broadcasting or watering. The use forms depend entirely on the intended purposes, especially on the species and cultivar of plant and on the plant part or plant product to which they are to be applied; in each case, the finest possible distribution of the active compounds employed according to the invention and also of the auxiliaries should be ensured.

The compounds of the formulae I and II mentioned are typically employed as formulations customary in the field of crop protection and the protection of supply products.

Customary formulations are, for example, solutions, emulsions, suspensions, dispersions, pastes, dusts, materials for broadcasting, powders and granules.

The formulations are prepared in a known manner, for example by extending the active compound with solvents and/or carriers, if desired with the use of emulsifiers and dispersants. Solvents/auxiliaries suitable for this purpose are essentially:
Water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, dimethyl fatty amides, fatty acids and fatty esters. In principle, it is also possible to use solvent mixtures.
Carriers, such as natural ground minerals (for example kaolins, clays, talc, chalk) and synthetic ground minerals (for example finely divided silica, silicates).
Surfactants, such as alkali metal, alkaline earth metal and ammonium salts of aromatic sulfonic acids, for example lignosulfonic acid, phenolsulfonic acid, naphthalenesulfonic acid and dibutylnaphthalenesulfonic acid, and also fatty acids, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctyl phenol, octyl phenol or nonyl phenol, alkylphenol polyglycol ethers, tributylphenyl polyglycol ether, tristerylphenyl polyglycol ether, alkylaryl polyether alcohols, isotridecyl alcohol, alcohol and fatty alcohol/ethylene oxide condensates, ethoxylated castor oil, polyoxyethylene alkyl ethers or polyoxypropylene alkyl ethers, ethoxylated polyoxypropylene, lauryl alcohol polyglycol ether acetate, sorbitol esters, lignosulfite waste liquors, methylcellulose or siloxanes. Suitable siloxanes are, for example, polyether/polymethylsiloxane copolymers, which are also referred to as “spreaders” or “penetrants”.

Inert formulation auxiliaries suitable in particular for preparing directly sprayable solutions, emulsions, pastes or oil dispersions are essentially: mineral oil fractions of medium to high boiling point, such as kerosene or diesel oil, furthermore coal tar oils and oils of vegetable or animal origin, aliphatic, cyclic and aromatic hydrocarbons, for example toluene, xylenes, paraffins, tetrahydronaphthalene, alkylated naphthalenes or derivatives thereof, alcohols, such as methanol, ethanol, propanol, butanol and cyclohexanol, ketones, such as cyclohexanone and isophorone, strongly polar solvents, for example dimethyl sulfoxide, N-methylpyrrolidone or water.

Powders, materials for broadcasting and dusts can be prepared by mixing or jointly grinding the active substances with a solid carrier.

Granules, for example coated granules, impregnated granules and homogeneous granules, can be prepared by binding the active compounds to solid carriers.

Solid carriers are, for example, mineral earths, such as silica gels, silicates, talc, kaolin, attaclay, limestone, lime, chalk, bole, loess, clay, dolomite, diatomaceous earth, calcium sulfate and magnesium sulfate, magnesium oxide, ground synthetic materials, fertilizers, such as, for example, ammonium sulfate, ammonium phosphate, ammonium nitrate, ureas and vegetable products, such as cereal meal, tree bark meal, wood meal and nutshell meal, cellulose powders and other solid carriers.

The formulations generally comprise the compounds (I) and/or (II) in a total amount of from 0.01 to 95% by weight, preferably from 0.1 to 90% by weight, based on the total weight of the formulation.

Products (formulations) for dilution with water are, for example, water-soluble concentrates (SL), dispersible concentrates (DC), emulsifiable concentrates (EC), emulsions (EW, EO), suspensions (SC, OD), water-dispersible and water-soluble granules (WG, SG) and also water-dispersible and water-soluble powders (WP, SP). Products (formulations) for direct application are, for example, dusts (DP), granules (GR, FG, GG, MG) and ULV solutions (UL).

Aqueous use forms can be prepared from storage-stable formulations, such as concentrated solutions, emulsion concentrates, suspensions, pastes, wettable powders (spray powders, oil dispersions) or water-dispersible granules, by addition of water, and they can be applied, for example, by spraying.

To prepare emulsions, pastes or oil dispersions, the compounds of the formulae (I) and/or (II) are dissolved as such or in an oil or solvent and can be homogenized in water using wetting agents, tackifier, dispersants or emulsifiers. However, it is also possible to prepare concentrates from the active substance and wetting agent, tackifier, dispersant or emulsifier and, if appropriate, solvent or oil, which concentrates are suitable for dilution with water. Naturally, the use forms will comprise the auxiliaries used in the storage-stable formulations.

The active compound concentrations in the preparations diluted with water may vary within relatively wide ranges. In general, they are between 0.0001 and 10% by weight, preferably between 0.01 and 1% by weight.

Oils of various types, wetting agents, adjuvants, fungicides, insecticides, bactericides, other growth regulators or else fertilizers can be added to the active compounds, if need be even immediately prior to application (tank mix). These agents can be added to the compositions used according to the invention in a weight ratio of from 1:100 to 100:1, preferably from 1:10 to 10:1.

Suitable adjuvants in this sense are in particular: organically modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctylsulfosuccinate, for example Leophen RA®.

The combined use of the compounds (I) and/or (II) with further active compounds customary in crop protection, for example with fungicides, can take place either by using a mixture of these active compounds (for example a joint formulation or a tank mix) or by successive application of the individual active compounds.

Particularly suitable is the use of the compounds (I) and/or (II) in combination with at least one fungicide.

The following list of fungicides with which the compounds (I) and/or (II) to be used according to the invention can be applied jointly is intended to illustrate the possible combinations, but not to limit them:
acylalanines, such as benalaxyl, metalaxyl, ofurace, oxadixyl,
amine derivatives, such as aldimorph, dodine, dodemorph, fenpropimorph, fenpropidin, guazatine, iminoctadine, spiroxamine, tridemorph,
anilinopyrimidines, such as pyrimethanil, mepanipyrim or cyprodinil,
antibiotics, such as cycloheximide, griseofulvin, casugamycin, natamycin, polyoxin or streptomycin,
azoles, such as bitertanol, Bromoconazole, cyproconazole, difenoconazole, dinitroconazole, epoxiconazole, fenbuconazole, fluquinconazole, flusilazole, hexaconazole, imazalil, metconazole, myclobutanil, penconazole, propiconazole, prochloraz, prothioconazole, tebuconazole, triadimefon, triadimenol, triflumizole, triticonazole,
dicarboximides, such as iprodione, myclozolin, procymidone, vinclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophanate-methyl, tiadinil, tricyclazole, triforine,
copper fungicides, such as Bordeaux mixture, copper acetate, copper oxychloride, basic copper sulfate,
nitrophenyl derivatives, such as binapacryl, dinocap, dinobuton, nitrophthal-isopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, toloclofos-methyl, quintozene, zoxamide,
strobilurins, such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet, tolylfluanid
cinnamides and analogous compounds, such as dimethomorph, flumetover or flumorph.

The fungicides are preferably selected from the group consisting of metconazole, tebuconazole, prothioconazole, epiconazole, fenpropimorph, dimoxystrobin and kresoxim-methyl. The fungicides are particularly preferably selected from the group consisting of metconazole, tebuconazole and prothioconazole.

In a preferred embodiment for field applications, i.e. application to live plants or plant parts thereof, the compounds of the formula (I) and/or (II) are used in the form of an aqueous spray liquor. Application is preferably by spraying. Here, the spray liquor is applied either to the entire above-ground part of the plant or else only to individual plant parts, such as, flowers, fruits, leaves or individual shoots. The choice of the individual plant parts to which the spray liquor is to be applied depends on the plant species and on its development stage. Application is preferably to the entire above-ground part of the plant or else to the parts which require particular protection against toxin contamination or which are preferably infected by trichothecene-forming fungi.

In general, in the case of field application, the compounds of the formulae (I) and/or (II) are employed in a total amount of from 5 to 3000 g/ha, preferably from 50 to 1000 g/ha and particularly preferably from 100 to 500 g/ha per season.

Specifically, it is preferred under field conditions to apply the following amounts of active substance per season:
Acylcyclohexanediones (I) (for example trinexapac-ethyl or prohexadione-Ca): preferably from 5 to 1000 g; particularly preferably from 25 to 500 g; in particular from 50 to 200 g; specifically for rice: in particular: 10 to 50 g.
Quaternary ammonium compounds (II) (for example chlormequat chloride or mepiquat chloride); preferably from 50 to 3000 g; particularly preferably from 100 to 2000 g; in particular from 200 to 1500 g.

If mixtures of compounds (I) and (II) are used for field application, their ratio is preferably from 2:1 to 1:30, particularly preferably from 1:1 to 1:20 and especially from 1:2 to 1:10, for example about 1:6.

Per season, the compounds (I) and/or (II) are preferably applied 1 to 5 times, particularly preferably 1 to 3 times and especially once or twice.

In a preferred embodiment for stored harvested material (for example cereal in a silo), the compounds of the formulae (I) and/or (II) are used in the form of dusts.

In general, in the case of application on stored harvested material, the compounds of the formulae (I) and/or (II) are employed in a total amount of from 0.1 to 700 g, preferably from 0.5 to 120 g and particularly preferably from 1 to 60 g per metric ton of harvested material.

Specifically, it is preferred to apply evenly, per metric ton of stored harvested material, the following amounts of active substance:
Acylcyclohexanediones (I) (for example trinexapac-ethyl or prohexadione-Ca): preferably from 0.1 to 500 g; particularly preferably from 0.5 to 100 g; especially from 1 to 50 g.
Quaternary ammonium compounds (II) (for example chlormequat chloride or mepiquat chloride): preferably from 0.1 to 200 g; particularly preferably from 0.5 to 20 g; especially from 1 to 10 g.

If mixtures of compounds (I) and (II) are used for stored harvested material, their ratio is preferably from 1:10 to 10:1, particularly preferably from 1:5 to 10:1 and especially from 1:1 to 6:1, for example about 5:1.

The present invention furthermore provides a method for reducing or preventing the contamination of plants and plant products with toxins formed by trichothecene-producing fungi, where a plant, a plant part or a plant product is brought into contact with at least one compound selected from the group consisting of acylcyclohexane-diones of the formula (I) or salts thereof and quaternary ammonium compounds of the formula (II) or mixtures thereof.

For preferred compounds of the formula (I) and (II) and for the amount and manner in which they are employed, reference is made to what has been said above.

By using growth regulators of the formula (I) and/or (II), the formation of trichothecene-toxins and other mycotoxins originating from trichothecene-producing harmful fungi is reduced considerably. This reduction is based not on a fungicidal action of the growth regulators used, which would result in the death of the toxin-producing harmful fungi, but, in particular, on the inhibition of the biosynthesis of trichothecenes and other mycotoxins in these harmful fungi. In this manner, it is possible to suppress contamination with mycotoxins of plants and plant products even in cases where the harmful fungi do not react or not sufficiently to the fungicides employed.

The examples below are intended to illustrate the invention, but without limiting it.

### EXAMPLES

### 1. Reduction of the Contamination of Wheat Grains with Deoxynivalenol (DON) after Treatment with Prohexadione-Ca Under Field Conditions

Winter wheat of the cultivar “Ritmo” was cultivated under customary conditions at the Tachenhausen site (Baden-Württemberg) in 2004. In May or June (exact dates see Table 1), the cereal was treated with two different fungicide mixtures alone or in combination with prohexadione-Ca (used in the form of the commercially available product REGALIS) by spraying at about 300 l/ha. Owing to favorable infection conditions, there was a relatively intensive natural infection of the ears with Fusarium fungi. On Jul. 12, 2004, the infection of the ears with Fusarium fungi was determined. The wheat grains were harvested on Aug. 3, 2004. The DON content of the grains was determined, after extraction and analysis, by HPLC/MS. For a comparative evaluation, the Fusarium infection, the DON value and the grain yield found for untreated wheat were defined as 100%. The values found for treated wheat are expressed in Table 1 as relative values, i.e. as percentages, based on this 100%.

TABLE 1

| | | | | | DON | |
|---|---|---|---|---|---|---|
| | Treatment | | | | content² | |
| | | Application | | Infec- | of the | Grain |
| | | rate | Date | tion¹ | grains | yield³ |
| Ex | Active compound | [g/ha] | 2004 | [%] | [%] | [%] |
| 1 | — | — | — | 100 | 100 | 100 |
| 2⁴ | kresoxim-methyl + | 100 | 13.5. | 96 | 79 | 111 |
| | epoxiconazole + | 100 | 13.5. | | | |
| | fenpropimorph | 100 | 13.5. | | | |
| 3⁴ | kresoxim-methyl + | 100 | 13.5. | 88 | 31 | 114 |
| | epoxiconazole + | 100 | 13.5. | | | |
| | fenpropimorph | 100 | 13.5. | | | |
| | prohexadione-Ca | 50 | 01.6. | | | |
| 4⁵ | kresoxim-methyl + | 100 | 13.5. | 13 | 12 | 124 |
| | epoxiconazole + | 100 | 13.5. | | | |
| | fenpropimorph | 100 | 13.5. | | | |
| | dimoxystrobin + | 200 | 07.6. | | | |
| | epoxiconazole | 75 | 07.6. | | | |
| | metconazole | 60 | 07.6. | | | |
| 5⁵ | kresoxim-methyl + | 100 | 13.5. | 12 | 5 | 125 |
| | epoxiconazole + | 100 | 13.5. | | | |
| | fenpropimorph | 100 | 13.5. | | | |
| | dimoxystrobin + | 200 | 07.6. | | | |
| | epoxiconazole | 75 | 07.6. | | | |
| | metconazole | 60 | 07.6. | | | |
| | prohexadione-Ca | 50 | 07.6. | | | |

¹100% = 27.3% of the ears are infected by Fusarium fungi
²100% = 14.1 mg of DON per kg of harvested grains
³100% = 11.2 t/ha
⁴trade name of the fungicide mixture used: Juwel Top (kresoxim-methyl, epoxiconazole, fenpropimorph)
⁵trade name of the fungicide mixtures used: Juwel Top, Swing Gold (dimoxystrobin, epoxiconazole) and Caramba (metconazole)

As comparison of Examples 2 and 3 or 4 and 5 shows, the use of prohexadione-Ca results in a reduced DON content of the harvested wheat grains. This means that prohexadione-Ca, used in addition to the fungicides employed in each case, results in a reduced contamination of the grains with DON compared to the treatment with the respective fungicides alone, in the case of a comparable Fusarium infection.

### 2. Reduction in the Contamination of Wheat Grains with Deoxynivalenol (DON) and Nivalenol (NIV) after Treatment with Prohexadione-Ca Under Field Conditions

Winter wheat of the cultivar “Ritmo” was cultivated under customary conditions at the Gronau site (Rheinland-Pfalz) in 2004. On Jun. 7, 2004, at the beginning of flowering, the cereal was treated with prohexadione-Ca (applied as REGALIS). Owing to favorable infection conditions, there was a relatively intensive natural infection of the ears with Fusarium fungi. On Jun. 28, 2004, the infection of the ears with Fusarium fungi was determined. The wheat grains were harvested on Aug. 9, 2004. The DON content and the NIV content of the grains was determined after extraction by HPLC/MS. Evaluation was carried out analogously to Example 1.

TABLE 2

| | | | | Content of the | | |
|---|---|---|---|---|---|---|
| | Treatment | | | grains of | | Grain |
| | | Application | | DON² | NIV³ | yield⁴ |
| Ex | Active compound | rate [g/ha] | Infection¹ | [%] | [%] | [%] |
| 6 | — | — | 100 | 100 | 100 | 100 |
| 7 | prohexadione-Ca | 50 | 91 | 81 | 75 | 109 |

¹100% = 43.8% of the ears are infected by Fusarium fungi
²100% = 22.4 mg of DON per kg of harvested grains
³100% = 0.45 mg of NIV per kg of harvested grains
⁴100% = 2.9 t/ha

The results show that the active compound prohexadione-Ca reduces the content of DON and NIV considerably. This effect is substantially independent of the infection of the ears with Fusarium fungi.

### 3. Reduction of the Contamination of Wheat Grains with Deoxynivalenol (DON) and Zearalenone (ZEA) after Treatment with Prohexadione-Ca Under Field Conditions

Winter wheat of the cultivar “Slade” was cultivated under customary conditions on the Ulhówek site (Poland) in 2004. On Jun. 10, 2004 or Jun. 19, 2004, at the beginning of flowering, the cereal was treated either with prohexadione-Ca (applied as REGALIS) or with the fungicide metconazole (applied as the commercially available product “Caramba”). Under the given cultivation conditions, there was a relatively light natural infection of the ears with Fusarium fungi. On Jul. 22, 2004, the infection of the ears with Fusarium fungi was determined. The wheat grains were harvested on Aug. 16, 2004. The DON content and the ZEA content of the grains was, after extraction, determined by HPLC/MS. Evaluation was carried out analogously to Example 1.

TABLE 3

| | | | | | ZEA² | |
|---|---|---|---|---|---|---|
| | | | | | content | |
| | | | | | of the | Grain |
| | Treatment | | | | grains | yield³ |
| Ex | Active compound | Dose | Date | Infection¹ | [%] | [%] |
| 8 | — | — | | 100 | 100 | 100 |
| 9 | prohexadione-Ca | 50 | 10.6. | 78 | 23 | 98 |
| 10 | metconazole | 90 | 10.6. | 18 | 53 | 108 |
| 11 | prohexadione-Ca | 50 | 19.6. | 51 | 32 | 105 |
| 12 | metconazole | 90 | 19.6. | 18 | 33 | 110 |

¹100% = 4.5% of the ears are infected by Fusarium fungi
²100% = 0.073 mg of NIV per kg of harvested grains
³100% = 8.6 t/ha

The experiment shows that the active compound prohexadione-Ca reduces the DON and ZEA contents considerably. In this test, the effect of the fungicide metconazole is almost reached, although the latter has a considerably more intense effect on the fungal infection.

1-15. (canceled)

16. A method for reducing or preventing the contamination of plants or plant products with mycotoxins formed by trichothecene-producing fungi, which comprises treating plants, plant parts thereof or plant products with at least one compound of the formula I 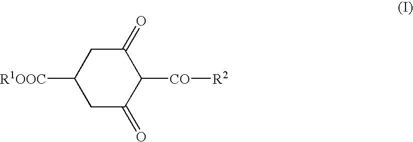
in which
R¹ is H or C₁-C₁₀-alkyl and
R² is C₁-C₁₀-alkyl or C₃-C₁₀-cycloalkyl
or salts thereof.

17. The method according to claim 16, where the trichothecene-producing fungi are those of the genera Fusarium, Trichoderma or Stachybotrys.

18. The method according to claim 16, where the toxins are trichothecenes or zearalenone.

19. The method according to claim 18, where the trichothecenes are selected from the group consisting of deoxynivalenol, nivalenol, 3- and 15-acetoxynivalenol, T-2 toxin, HT-2 toxin, neosolaniol, monoacetoxyscirpenol, diacetoxyscirpenol, 15-acetoxyscirpendiol, fusarenone, T-2 tetraol and verrucarol.

20. The method according to claim 16 where the plants are selected from the group consisting of cereal, potato, sugar beet, tomato, pea, leek, asparagus, fodder grasses and fodder clover.

21. The method according to claim 20, where the plants are selected from the group consisting of wheat, barley, rye, triticale, oats, rice and corn.

22. The method according to claim 16, where the alkali metal or alkaline earth metal salts of compounds of the formula (I) where R¹ is H are used.

23. The method according to claim 22, where R² is ethyl.

24. The method according to claim 22, where the calcium salt is used.

25. The method according to claim 16, where in compounds of the formula (I) R¹ is ethyl and R² is cyclopropyl.
